(19) United States
(12) Patent Application Publication
(10) Pub. No.: US 2007/0081772 A1
(43) Pub. Date: Apr. 12, 2007

(54) Automatic current selection for single fiber splicing

(75) Inventors: Richard Mendel, Stockholm (SE); Robert Rylander, Sundbyberg (SE)

Correspondence Address: POTOMAC PATENT GROUP, PLLC, P. O. BOX 270, FREDERICKSBURG, VA, 22404, US

(73) Assignee: Future Instrument Fiber Optics AB, Bromma (SE)

(21) Appl. No.: 10/575,128

(22) PCT Filed: Oct. 8, 2004
(86) PCT No.: PCT/SE04/01442

§ 371 Date: Jul. 25, 2006

(30) Foreign Application Priority Data
Oct. 10, 2003 (SE) 0302696-0

(51) Int. Cl. G02B 6/255

(52) U.S. Cl. 385/96

(57) ABSTRACT

In fusion splicing ends of two optical fibers an electric discharge between two electrodes is used for heating the ends. In a simple method that can be implemented in automatic fusion splicers, an optimal fusion current that is to pass between the electrodes to give an optimal heating for ambient conditions is determined by first, in a calibration procedure in the factory, determining an optimal current for splicing ends of some test optical fibers. Then a value of the intensity of light emitted from the ends of the test optical fibers is determined when they are spliced using the optimal parameters. In the field, in generally ambient conditions different from those in the factory, a value of the current required to heat a piece of the test fibers to emit light of an intensity agreeing with that determined for the test fibers in the factory. A proportional change is calculated by mathematically dividing the value of the current required for heating the test fiber in the field conditions by the optimal current determined in the factory. A value of the fusion current to be used in splicing the fiber to each other is calculated by modifying, by the calculated proportional change, the fusion current that should be used for fibers in the factory ambient conditions. Finally, the fusion current used in the actual splicing of the ends of the two optical fibers to each other is controlled to take the calculated value.

### RELATED APPLICATIONS

This application claims priority and benefit from Swedish patent application No. 0302696-0, filed Oct. 10, 2003, the entire teachings of which are incorporated herein by reference.

### TECHNICAL FIELD

The present invention relates to methods and devices for determining an optimal fusion current to be used in splicing optical fibers to each other and for splicing two optical fibers to each other and for controlling the fusion current to take an optimal value.

### BACKGROUND OF THE INVENTION

In fusion splicing optical fibers to each other using an electric discharge generated between two electrodes, one of the most important parameters to be selected in the best possible way is the electrode current or fusion current passing between the electrodes in the discharge that specifically is a glow discharge though it sometimes is called an “electric arc”. The electrode current must be determined correctly in order to obtain a low loss and high strength of the splice and an accurate estimation of the optical loss in the splice, see e.g. U.S. Pat. Nos. 5,909,527 for Wenxin Zheng and 6,097,426 for Sasan Esmeili. Optical fibers of different kinds often need different fusion currents. Even for optical fibers of the same kind, obtained from the same manufacturer, the optimal fusion current varies significantly for different environmental conditions.

### SUMMARY OF THE INVENTION

It is an object of the invention to provide a method and device for determining an optimal fusion current to be used in splicing optical fibers to each other and for controlling the fusion current to take an optimal value, the method and device having a simple structure and being capable of an easy implementation in commercially available splicing devices.

In determining an optimal fusion current to be made to pass between electrodes for splicing the ends of two optical fibers to each other, as will be described herein, it is assumed that the light intensity emitted from the fibers is dependent on the current used in the heating the fibers in an electric discharge between the splicing electrodes and that an optimal splice between the fibers is obtained when the temperature of the fiber ends during the splicing process is equal to a fixed value, which is independent of various ambient conditions such as the altitude.

Thus, in a factory adjustment of an automatic splicer two ordinary optical fibers are spliced to each other. As a starting point, splices are made using some default splicing parameters. An optimal fusion current is determined by optical loss measurements of the splices made. Possibly more than one splice has to be made before an optimal fusion current is found. The fusion current is changed in small steps for each new splice made until a resulting optimal splice is achieved. For each splicing operation and in particular for that one producing the splice having the best characteristics, i.e. the lowest optical loss, the intensity of the light emitted from the fiber ends during the splicing process is measured and stored. The intensity of light can be measured as the average intensity in a predetermined region of a captured image. The measured intensity for splice having the best characteristics is stored in the splicer.

Then, when using the fiber splicer in the field, pieces of an optical fiber of the same type that was used for determining the optimal fusion current for the splice having the best characteristics and for which the light intensity was stored are used when calibrating the splicer. A piece of optical fiber of this type is placed in the splicer and a calibration procedure is executed.

In the calibration procedure the electric discharge is started using the recorded fusion current for the originally used optical fibers. The light intensity emitted by the heated portion of the optical fiber piece is measured and compared to the recorded light intensity. If the measured and recorded intensity values are sufficiently close to each other, the calibration is finished. If they are not, the fusion current is changed in small steps until for some fusion current the measured and recorded intensity values actually are sufficiently close to each other, i.e. deviates from each other by an amount smaller than some predetermined value. The value of the new fusion current is stored and the proportional change of the originally stored value of the fusion current that is required to obtain the desired light intensity is calculated and stored. The current compensation proportion has now been determined for the local environmental conditions and the calibration procedure is then terminated. The calculated proportional current compensation is then applied to all fusion currents used for splicing, regardless of fiber type.

Additional objects and advantages of the invention will be set forth in the description which follows, and in part will be obvious from the description, or may be learned by practice of the invention. The objects and advantages of the invention may be realized and obtained by means of the methods, processes, instrumentalities and combinations particularly pointed out in the appended claims.

### BRIEF DESCRIPTION OF THE DRAWINGS

While the novel features of the invention are set forth with particularly in the appended claims, a complete understanding of the invention, both as to organization and content, and of the above and other features thereof may be gained from and the invention will be better appreciated from a consideration of the following detailed description of non-limiting embodiments presented hereinbelow with reference to the accompanying drawings, in which:

FIG. 1 is a schematic picture illustrating the electric control of an optical fiber splicer,

FIG. 2 is a flow diagram of a procedure for calibrating an optical fiber splicer in the field, and

FIG. 3 is picture of a splicing position illustrating a suitable field for determining an average emitted light intensity.

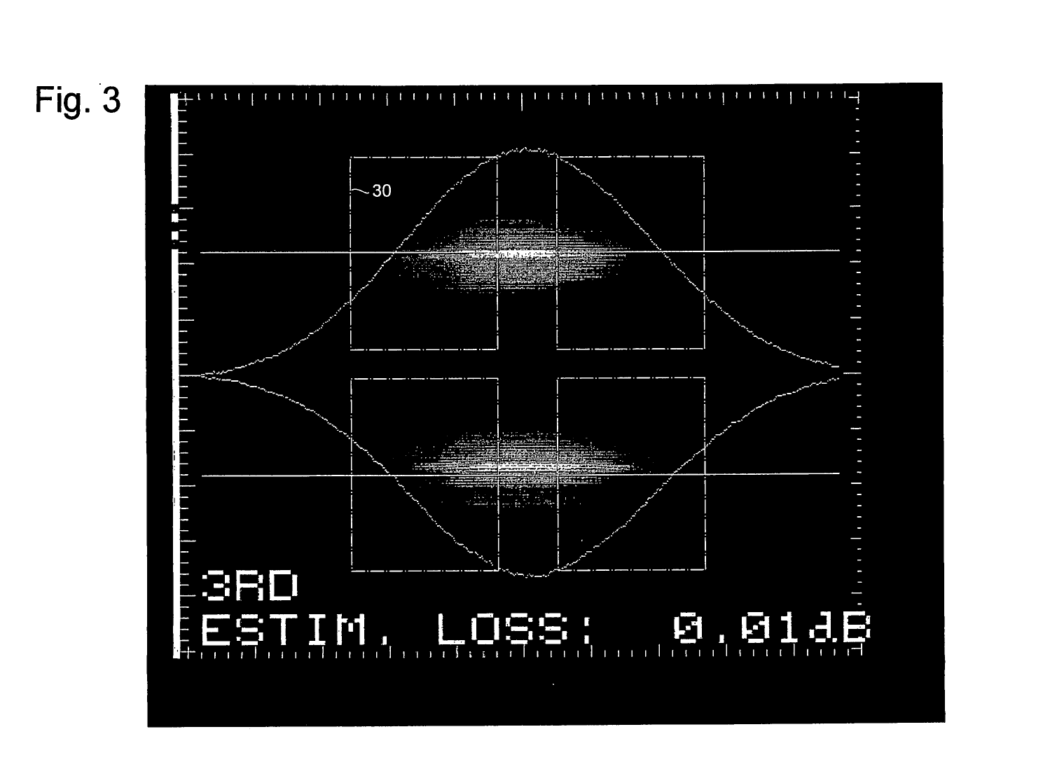

### DETAILED DESCRIPTION

When an optical fiber is heated, the thermal radiation emitted from the fiber can be observed served using a video-camera and analyzed using a digital image processing system of a splicer, e.g. as described in W. Zheng, O. Hultén and R. Rylander, “Erbium-doped fiber splicing and splice loss estimation”, IEEE J. of Lightwave Technology, Vol. 12, No. 3, pp. 430-435, March 1994. During splicing, the radiant emissivity, consequently also the luminescence intensity from the heated fiber, is a function of the temperature at the fiber ends, see T. Katagiri et al., “Direct core observation method using thermal radiation of silica fibers with dopants”, Elec. and Comm. in Japan, Vol. 71, No. 11, pp.-85, 1988. This effect can be used in an automatic fiber splicer to adjust parameters of the splicing process to varying ambient conditions.

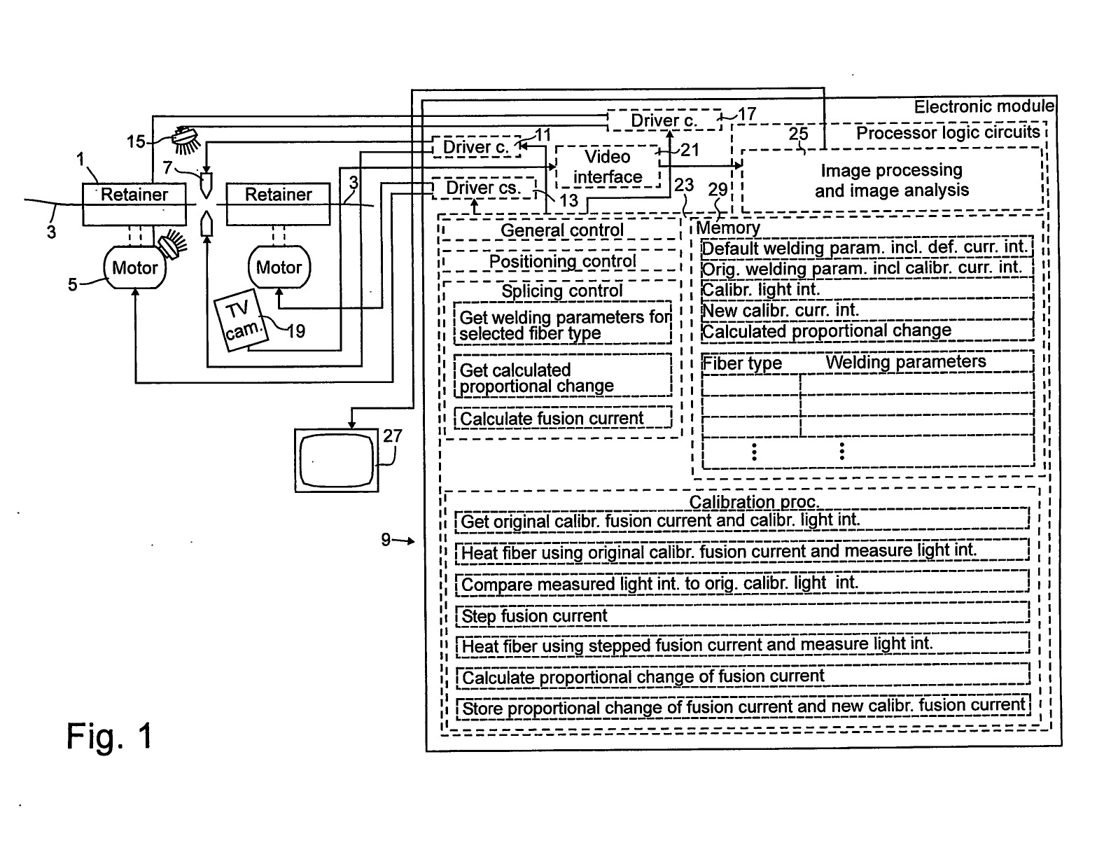

A fiber splicing device of the automatic type is schematically shown in FIG. 1. This device has clamps 1, also called retainers, in which end portions of optical fibers 3 are placed and retained during adjusting their position and in the welding process. The clamps 1 are displaceable in a direction parallel to the longitudinal direction of the fibers. The clamps 1 can also be displaceable in directions perpendicular to the fiber longitudinal direction in order to align the fibers with each other or an alignment can be produced by placing the fiber ends in V-grooves or similar fixed mechanical guides. The clamps 1 are operated along suitable mechanical guides, not shown, by control motors 5. Electrical lines to electrodes 7 and to the motors 5 extend from an electronic circuit module 9, from associated driver circuits 11 and 13 respectively arranged therein. The splicing position between the electrodes can be illuminated, if required, by light sources 15 driven by a circuit 17 in the electronic circuit module. From a CCD-camera 19 an electronic line is arranged to a camera interface 21 in the electronic circuit module 9, from which lines extend to a control unit 23, suitably a microprocessor. In particular, a video signal is provided to an image processing and image analyzing program module 25 of the microprocessor 23. It performs image processing in order to determine among other things the positions of the fiber ends and in order to determine the light intensity in selected areas in captured pictures. The image processing and analyzing module also provides a video signal to a monitor 27 in which primarily pictures of the splicing position can be shown. The control unit 23 is connected to and controls all the driver circuits 11, 13 and 17. It contains program modules for executing different tasks and a memory 29 storing parameters used in the splicing procedures.

Now a method of calibrating an automatic fiber splicer will be described. When adjusting such a splicer in the manufacture thereof, two ordinary optical fibers 3 of some given fiber type are spliced to each other. They are then first cut off, the ends of the fibers are placed in the clamps 1 and their cleaved surfaces are positioned close to each other. Some measuring device, not shown, is connected to the fibers for measuring the optical loss of light propagating from one of the fibers to the other. Such a device can include a light source connected to the remote end of the first fiber and a light power detector connected to the remote end of the second fiber. Thereupon, a manual or possibly automatic initial setting procedure is executed in which an optimal fusion current is determined by optical loss measurements. A first fiber splice is made using default values stored in the memory 29, in particular a default fusion current value and a default fusion time length value. The optical loss of the splice is determined and if it sufficiently low, the fusion current value used is stored as an calibration fusion current value in the memory, possibly together with other splicing parameters actually used such as the fusion time. If the optical loss is not sufficiently low, another splice is made using changed splicing parameters, such as a different fusion current value. Therefor, the splice made is removed and the two fibers are again cut off at their ends to obtain new end surfaces, the ends are placed in the clamps 1 and the end surfaces are positioned close to each other whereupon the actual new fusion splice is made. The loss of the splice is determined and it is decided whether it is sufficiently low. If it is, the parameters used are stored and otherwise another splice is made and the procedure is repeated until an acceptable low loss has been achieved. The parameters used for the splicing operation producing the splice having the acceptable loss are stored. When choosing new parameters to be used for splices in this procedure, e.g. the fusion current can be changed in small steps until arriving at the optimal one producing a splice of acceptable low loss.

For each splicing operation and in particular for that one producing the splice having the best characteristics, i.e. the lowest optical loss, the intensity of the light emitted from the fiber ends during the splicing operation is recorded and measured, using the camera 9 and the image processing and analysis module 25. The intensity of light can be measured as the average intensity in a predetermined field in a picture of the splicing position captured by the camera, the field having a fixed geometrical position in relation to particularly the heating source, i.e. the electric discharge that specifically can be a glow discharge and to the points of the electrodes. The measured intensity for splice having the best characteristics is stored in the memory 29 as the value “Calibration light intensity”.

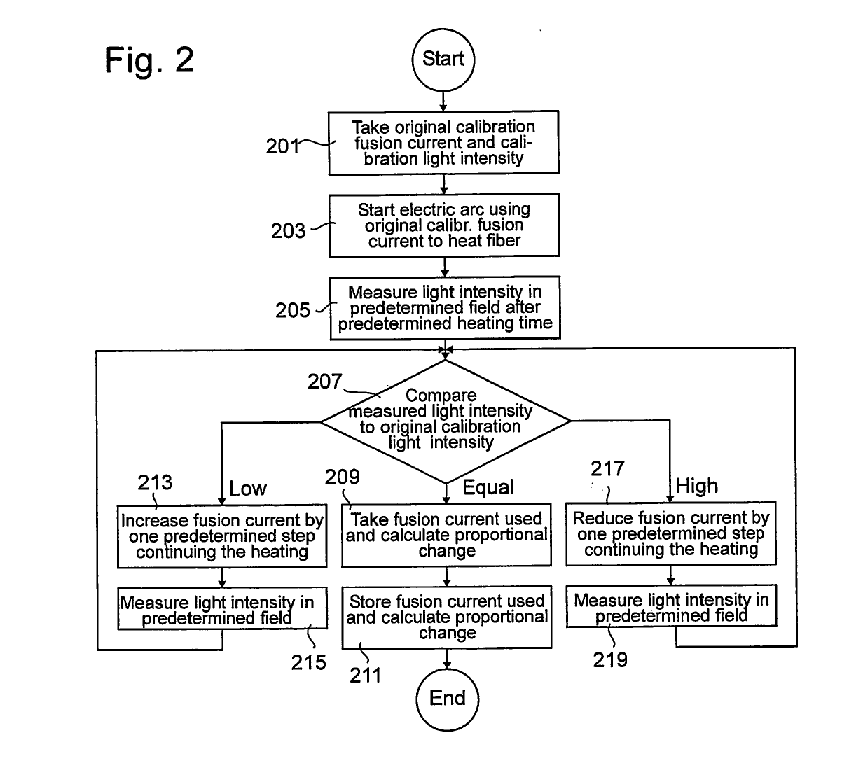

Then, when using the fiber splicer in the field, pieces of the same optical fiber that was used for determining the fusion current for the splice having the best characteristics and for which the light intensity was stored can be used for calibrating the splicer. For example, in the case where the operator thinks that the ambient conditions differ significantly from those of the place where the splicer was initially manufactured, a calibration is made. The operator then takes a piece of said same optical fiber and places a whole length thereof between the clamps of the splicer. The operator thereupon presses a button named “Calibration”, not shown, and then the splicer enters a special “calibration state” in which a calibration procedure is executed, see the flow diagram of FIG. 2.

In the first step 201 of the calibration procedure the original parameters used in the splicing operation, in particular the value of the fusion current used, giving the optimal low loss are retrieved from the memory 29 and also the stored calibration light intensity value. In the next step 203 the electric discharge is started using the retrieved splicing parameters, in particular the recorded fusion current. During the heating, after heating for a sufficient time, preferably the same time after starting the heating during the initial factory setting operation, at least one picture of the splicing position is captured and from the predetermined region of the picture the light intensity is determined, see next step 205. In step 207 the measured light intensity is compared to the originally stored calibration light intensity. If the measured and original intensity values are sufficiently close to each other, a step 209 is executed in which the fusion current now used for the heating is mathematically divided by the originally used fusion current to calculate the proportional change. Then the calculated value of the proportional change is stored in the memory 29. Thereafter, the calibration process is finished.

If it is decided in the comparing step 207 that the now measured light intensity is smaller than the calibration light intensity, the current in the electric discharge is increased by a predetermined, small increment value in step 211. Thereupon, in a step 213, in the same way as in step 205, at least one picture of the splicing position is captured and from the predetermined field of the picture the light intensity is determined. Then the comparing step 207 is again executed. If it is decided in the comparing step 207 that the now measured light intensity is larger than the calibration light intensity, the current in the discharge is reduced by a predetermined, small decrement value in step 215. Thereupon, in a step 217, in the same way as in steps 205 and 213, at least one picture of the splicing position is captured and from the predetermined field of the picture the emitted light intensity is determined. Then the comparing step 207 is again executed.

After executing the calibration process, the automatic fusion splicer is ready for splicing fibers. Then ends of two optical fibers, of any type for which the splicer is designed, are prepared and placed in the clamps 3 and their end surfaces are positioned at each other. The processor 23 retrieves the splicing parameters for the type to which the two optical fibers belong from a list stored in the memory 29. Then the processor calculates a fusion current to be used for the splicing operation to be executed by taking the stored fused current value for this fiber kind and modifying this value in the same proportion that has been calculated in the calibration procedure. Thereupon, the automatic splicing operation is executed using the modified value of the fusion current.

Thus, a method of calibrating a fusion splicer has been described, the method obtaining optimal splicing parameters for different ambient conditions.

While specific embodiments of the invention have been illustrated and described herein, it is realized that numerous additional advantages, modifications and changes will readily occur to those skilled in the art. Therefore, the invention in its broader aspects is not limited to the specific details, representative devices and illustrated examples shown and described herein. Accordingly, various modifications may be made without departing from the spirit or scope of the general inventive concept as defined by the appended claims and their equivalents. It is therefore to be understood that the appended claims are intended to cover all such modifications and changes as fall within a true spirit and scope of the invention.

1. A method of determining an optimal fusion current for fusion splicing ends of two optical fibers to each other using an electric discharge between two electrodes, comprising the steps of:
determining optimal parameters including an optimal current for fusion splicing ends of test optical fibers of a first kind to each other in first ambient conditions,
determining a value of a calibration light intensity for light emitted from the ends of the test optical fibers when splicing them using the optimal parameters in the first ambient conditions,
in second ambient conditions, determining a value of the current required to heat a piece of the test optical fibers to emit light of an intensity agreeing with the calibration light intensity,
calculating a proportional change be mathematically dividing the value of the heating current by the optimal current in the first ambient conditions, and
calculating, for optical fibers of a second kind different from the first kind, a fusion current to be used in splicing ends of optical fibers of the second kind in the second ambient conditions, by modifying, by the calculated proportional change, an optimal fusion current used for splicing optical fibers of the second kind in the first ambient condition.

2. A method according to claim 1, wherein during the step of determining the light intensity an average of the intensity of light emitted from a predetermined region at the splicing position is calculated.

3. A method according to claim 1, wherein during splicing and heating processes pictures of the splicing position are captured and analyzed.

4. A device for determining a fusion current to be used in splicing ends of two optical fibers to each other by means of an electric discharge, comprising
electrodes for forming an electric discharge therebetween,
driver circuits connected to the electrodes for applying a high voltage therebetween and making a heating current pass between the electrodes in the electric discharge,
retaining and positioning holders for retaining ends of two optical fibers and for placing the fiber ends, with end surfaces at each other or in abutting relationship with each other, in a splicing position between points of the electrodes and in the electric discharge, comprising:
a measuring assembly for measuring the intensity of light emitted from ends of two optical fibers retained by the retaining and positioning holders,
first calculating circuits connected to the measuring assembly and the driver circuits, the control circuits arranged to calculate a proportional change from a calibration fusion current and a heating current,
a memory connected to the measuring assembly and the calculation circuits for storing a calibration light intensity and a calibration fusion current for test optical fibers, a value of the proportional change calculated by the first calculating circuits, and fusion splicing parameters including a fusion current for at least one optical fiber type different from that of the test optical fibers, and
second calculating circuits, connected to the memory, for calculating an optimal value of a fusion current, for fusion splicing ends of two optical fibers of the different type, from the fusion current stored for the different optical fiber type, by modifying by the stored proportional change.

5. A device according to claim 4, wherein the measuring assembly includes a camera for capturing pictures of the splicing position, the first calculating circuits means arranged to determine the light intensity as an average light intensity from a predetermined field in a captured picture.

6. A method of controlling, in fusion splicing ends of two optical fibers to each other using an electric discharge between two electrodes, a fusion current passing between the two electrodes, comprising the steps of:
determining optimal parameters including a value of an optimal current for fusion splicing ends of test optical fibers of a first kind to each other in first ambient conditions,
determining a value of a calibration light intensity for light emitted from the ends of the test optical fibers when fusion splicing them using the optimal parameters in the first ambient conditions,
in second ambient conditions, determining a value of the current required to heat a piece of the test optical fibers or of an optical fiber of the same kind as the test optical fibers to emit light of an intensity agreeing with the calibration light intensity,
calculating a proportional change by mathematically dividing the value of the current required for heating by the value of the optimal current in the first ambient conditions,
calculating, for optical fibers of a second kind different from the first kind, a value of a fusion current to be used in fusion splicing ends of two optical fibers of the second kind to each other, by modifying, by the calculated proportional change, a fusion current used for optical fibers of the second kind in the first ambient conditions, and
controlling the fusion current used in fusion splicing ends of two optical fibers of the second kind to each other to take the calculated value.

7. A method according to claim 6, wherein during the step of determining the light intensity an average of the intensity of light emitted from a predetermined region at the splicing position is calculated.

8. A method according to claim 6 wherein during the splicing and heating processes pictures of the splicing position are captured and analyzed.

9. A device for controlling, in splicing ends of two optical fibers to each other by means of an electric discharge, a fusion current passing in the electric discharge, comprising
electrodes for forming an electric discharge therebetween,
driver circuits connected to the electrodes for applying a high voltage therebetween and making a heating current pass between the electrodes in the electric discharge,
retaining and positioning holders for retaining ends of two optical fibers and for placing the fiber ends, with end surfaces at each other or in abutting relationship with each other, in a splicing position between points of the electrodes and in the electric discharge, comprising:
a measuring assembly for measuring the intensity of light emitted from ends of two optical fibers retained by the retaining and positioning holders,
first calculating circuits, connected to the measuring assembly and the driver circuits, for calculating a proportional change from a calibration fusion current and a heating current,
a memory connected to the measuring assembly and the first calculation circuits for storing a calibration light intensity and a calibration fusion current for test optical fibers, a proportional change, calculated by the first calculating circuits, and fusion splicing parameters including a fusion current for at least one optical fiber type different from that of the test optical fibers,
second calculating circuits, connected to the memory, for calculating a value of a fusion current from the fusion current stored for the different optical fiber type, by modifying it by the stored proportional change, and
control circuits connected to the second calculating circuits and the driver circuits for controlling the driver circuits to make a heating current pass between the electrodes, for fusion splicing ends of two optical fibers of the different type, the heating current having the value calculated by the second calculating circuits.

10. A device according to claim 9, wherein the measuring assembly includes a camera for capturing pictures of the splicing position, the first calculating circuits arranged to determine the light intensity as an average light intensity from a predetermined field in a captured picture.

11. A method of fusion splicing ends of two optical fibers to each other using an electric discharge between two electrodes, a fusion current passing between the two electrodes, comprising the steps of:
determining optimal parameters including a value of an optimal current for fusion splicing ends of test optical fibers to each other in first ambient conditions,
determining a value of a calibration light intensity for light emitted from the ends of the test optical fibers when fusion splicing them using the optimal parameters in the first ambient conditions,
in second ambient conditions, determining a value of the current required to heat a piece of the test optical fibers or of an optical fiber of the same kind as the test optical fibers to emit light of an intensity agreeing with the calibration light intensity,
calculating a proportional change by mathematically dividing the value of the current required for heating by the value of the optimal current in the first ambient conditions,
calculating, for the optical fibers to be fusion spliced to each other a value of a fusion current to be used in the fusion splicing, by modifying, by the calculated proportional change, a fusion current used for optical fibers to be fusion spliced to each other in the first ambient conditions, and
controlling the fusion current used in the fusion splicing of the ends of the two optical fibers to each other to take the calculated value.

12. A method according to claim 11, wherein during the step of determining the light intensity an average of the intensity of light emitted from a predetermined region at the splicing position is calculated.

13. A method according to claim 11, wherein during the fusion splicing and heating processes pictures of the splicing position are captured and analyzed.

14. A device for splicing ends of two optical fibers to each other by heating in an electric discharge, a fusion current passing in the electric discharge, comprising
electrodes for forming an electric discharge therebetween,
driver circuits connected to the electrodes for applying a high voltage therebetween and making a heating current pass between the electrodes in the electric discharge,
retaining and positioning holders for retaining ends of two optical fibers and for placing the ends, with end surfaces at each other or in abutting relationship with each other, in a splicing position between points of the electrodes and in the electric discharge, comprising:
a measuring assembly for measuring the intensity of light emitted from ends of two optical fibers retained by the retaining and positioning holders,
first calculating circuits, connected to the measuring assembly and the driver circuits, for calculating a proportional change from a calibration fusion current and a heating current,
a memory connected to the measuring assembly and the first calculation circuits for storing a calibration light intensity and a calibration fusion current for test optical fibers, a proportional change, calculated by the first calculating circuits, and fusion splicing parameters including a fusion current for the optical fibers to be fusion spliced to each other,
second calculating circuits, connected to the memory, for calculating a value of a fusion current from the fusion current stored for the optical fibers to be fusion spliced to each other, by modifying it by the stored proportional change, and
control circuits connected to the second calculating circuits and the driver circuits for controlling the driver circuits to make a heating current pass between the electrodes, for fusion splicing ends of the two optical fibers to be fusion spliced to each other, the heating current having the value calculated by the second calculating circuits.

15. A device according to claim 14, wherein the measuring assembly includes a camera for capturing pictures of the splicing position, the first calculating circuits arranged to determine the light intensity as an average light intensity from a predetermined field in a captured picture.
